(19) United States
(12) Patent Application Publication
(10) Pub. No.: US 2014/0152581 A1
(43) Pub. Date: Jun. 5, 2014

(54) FORCE AS A DEVICE ACTION MODIFIER

(71) Applicant: LENOVO (SINGAPORE) PTE. LTD., Singpaore (SG)

(72) Inventors: Michaela Rose Case, Raleigh, NC (US); Aaron Michael Stewart, Raleigh, NC (US); Thomas John Sluchak, Apex, NC (US)

(73) Assignee: LENOVO (SINGAPORE) PTE. LTD., Singpaore (SG)

(21) Appl. No.: 13/690,262

(22) Filed: Nov. 30, 2012

(51) Int. Cl. G06F 3/041

(52) U.S. Cl. CPC G06F 3/041
USPC 345/173

(57) ABSTRACT

An aspect provides a method, including: receiving force input in a z direction with respect to a planar surface of an input device of an information handling device; measuring the force input at the input device; and modifying one or more actions of the information handling device commensurate with the measured force input; wherein the one or more actions are associated with input along the planar surface. Other aspects are described and claimed.

### BACKGROUND

Information handling devices (“devices”), for example cell phones, smart phones, tablet devices, laptop and desktop computers, remote controls, alarm clocks, navigation systems, e-readers, etc., employ one or more of a multitude of available input devices. Among potential input devices are touch based input devices, for example touch screens, touch pads, track points, and mechanical buttons.

Users interface with a device using the input devices to control the device. For example, a user may provide input to a touch screen to scroll along a web page displayed on the touch screen, click a button or tap the touch screen to select an item in the display, etc. Given the plurality of available input devices, opportunities exist for exploiting inputs from input device(s) to modify information handling device response(s) actions in unique ways.

### BRIEF SUMMARY

In summary, one aspect provides a method, comprising: receiving force input in a z direction with respect to a planar surface of an input device of an information handling device; measuring the force input at the input device; and modifying one or more actions of the information handling device commensurate with the measured force input; wherein the one or more actions are associated with input along the planar surface.

Another aspect provides an information handling device, comprising: a input device having a planar surface; a force sensor coupled to the planar input device; one or more processors; and a memory operatively coupled to the one or more processors that stores instructions executable by the one or more processors to perform acts comprising: detecting, at the force sensor, a force input in a z direction with respect to the planar surface of the input device; measuring the force input at the input device based on the force input; and modifying one or more actions of the information handling device commensurate with the measured force input; wherein the one or more actions are associated with input along the planar surface.

A further aspect provides a program product, comprising: a storage medium having computer program code embodied therewith, the computer program code comprising: computer program code configured to receive force input in a z direction with respect to a planar surface of an input device of an information handling device; computer program code configured to measure the force input at the input device; and computer program code configured to modify one or more actions of the information handling device commensurate with the measured force input; wherein the one or more actions are associated with input along the planar surface.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device and components thereof.

FIG. 2 illustrates another example information handling device and components thereof.

FIG. 3 illustrates an example method of utilizing force as a device action modifier.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While various input devices exist for controlling information handling devices, the input devices have conventionally not made use of force to modify one or more default actions. For example, a force input may be provided by a user to control an information handling device, such as pressing on a mechanical button, providing a press to touch pad having force sensors associated therewith, or even via pressing on a resistive based touch screen device. However, the force input sensed is binary (present or not), as illustrated by the example of a mechanical button. Thus, conventional input devices have not been used to ascertain degree of force for use in combination with modifying one or more default actions, for example gain (i.e., speed) of a scrolling action, modification of a setting, feature or other default device parameter.

Accordingly, an embodiment uses the addition of force input in touch based devices (including but not limited to touch screen, touch pad, Track Point (optical or mechanical), mechanical buttons, and the like) to modify the characteristics of a default action (also referred to herein as simply “action”). A default action is defined herein as an action undertaken or executed by an information handling device in response to touch input, e.g., scrolling a display of a web page, etc. Thus, the input associated with action is for example input to a planar surface (e.g., coplanar to a surface of an information handling device, e.g., a touch pad or a touch screen). The input to the planar surface is for example touch input along the planar surface, e.g., a gesture or dragging input along a planar touch pad or touch screen.

The default action(s) are modified by an embodiment using force (e.g., force input in a downward or “z direction” with respect to the planar surface, e.g., tangential or perpendicular input with respect to the planar surface). An embodiment imparts an intensity level commensurate with the measured force input to modify of the default action. Thus, the modification depends on a change in the applied force of the contact, as sensed and measured using an input device. For example, the speed or acceleration of an action, such as cursor movement or scrolling, can be modified by force input. Force is also used as a granular form of input, with each change in the amount of force (e.g., over or under one or more thresholds) resulting in an adjustment of an action, such as in the speed or acceleration of scrolling.

The illustrated example embodiments will be best understood by reference to the figures. The following description is intended only by way of example, and simply illustrates certain example embodiments.

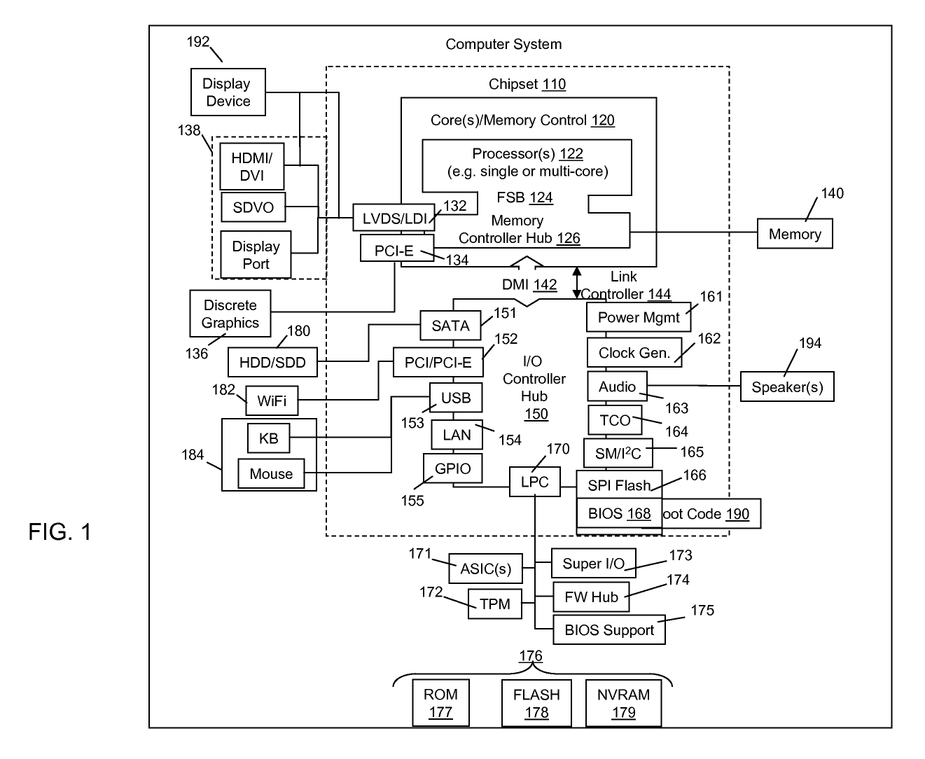

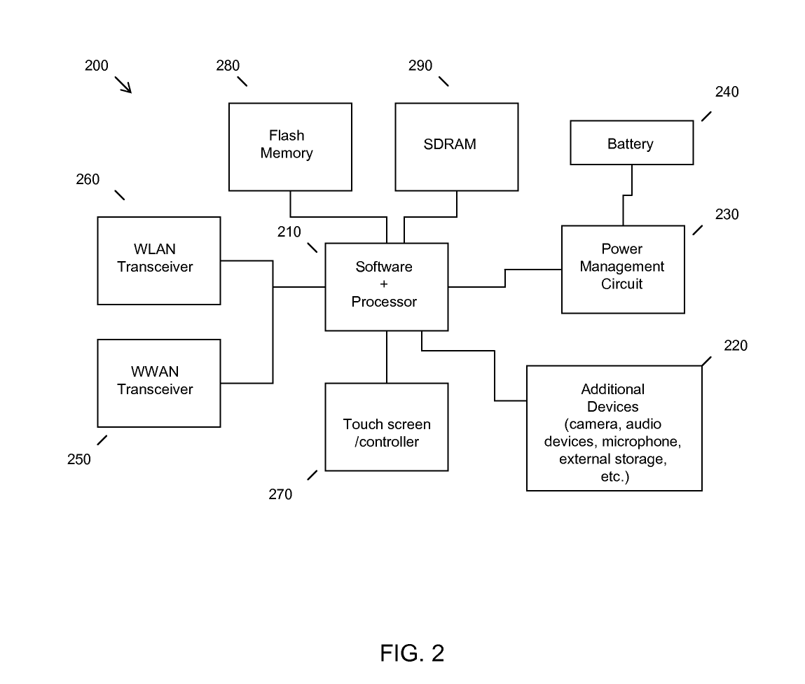

Referring to FIG. 1 and FIG. 2, while various other circuits, circuitry or components may be utilized, with regard to smart phone and/or tablet circuitry 200, an example illustrated in FIG. 2 includes an ARM based system (system on a chip) design, with software and processor(s) combined in a single chip 210. Internal busses and the like depend on different vendors, but essentially all the peripheral devices (220) may attach to a single chip 210. In contrast to the circuitry illustrated in FIG. 1, the tablet circuitry 200 combines the processor, memory control, and I/O controller hub all into a single chip 210. Also, ARM based systems 200 do not typically use SATA or PCI or LPC. Common interfaces for example include SDIO and I2C. There are power management chip(s) 230, which manage power as supplied for example via a rechargeable battery 240, which may be recharged by a connection to a power source (not shown), and in at least one design, a single chip, such as 210, is used to supply BIOS like functionality and DRAM memory.

ARM based systems 200 typically include one or more of a WWAN transceiver 250 and a WLAN transceiver 260 for connecting to various networks, such as telecommunications networks and wireless base stations. Commonly, an ARM based system 200 will include a touch screen 270 for data input and display. ARM based systems 200 also typically include various memory devices, for example flash memory 280 and SDRAM 290.

FIG. 1 depicts a block diagram of one example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Devices such as outlined in FIGS. 1 and 2 may include one or more input devices, including an input device configured to detect force of varying degree. For example, a force detecting input device may be based on a mechanical mechanism, such as a touch pad or mechanical button configured to depress to a varying degree dependent on force applied. Moreover, a force input device may measure force supplied by inferring it from a related measurement, as for example via use of a resistive layer within a touch screen.

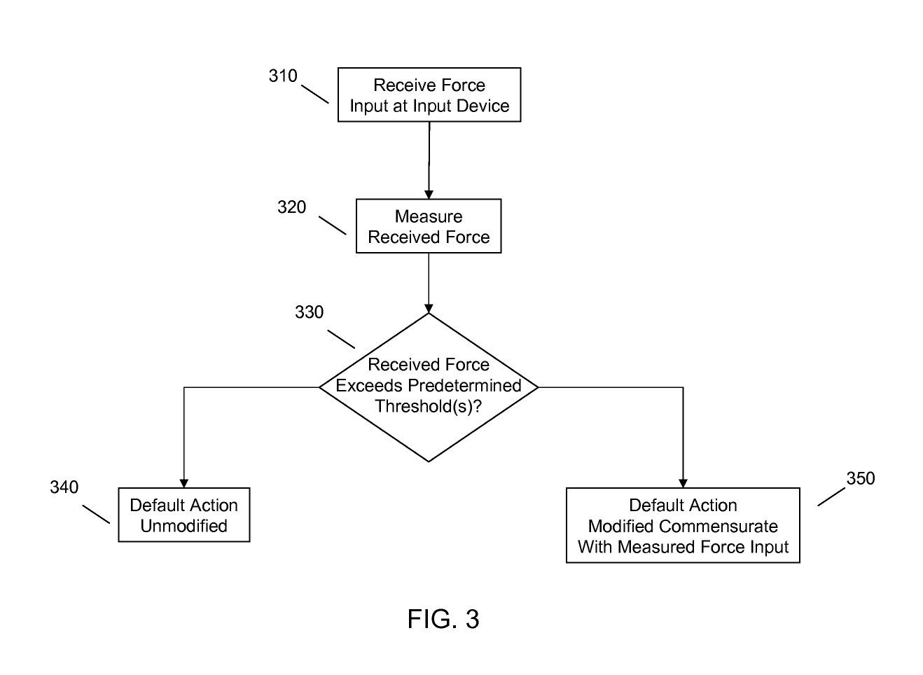

Referring to FIG. 3, irrespective of the input device(s) used to measure a force input, when a force input is received 310, the force input device may generate a signal that is proportionate to the force input received. This signal (or signals) may be used to measure at 320 the force received via the input device, such as correlating a signal strength or intensity value to a predetermined level of force. Given a measurement of input force received via an input device, the measured force may be compared to one or more thresholds at 330. The thresholds may be set as desired and may be modified by a user such that differing amounts of force trigger different modifications, for example according to a response curve. Thus, force below a threshold as determined at 330 may result in no modification to an action, e.g., scrolling speed, at 340.

However, if the force input measured at 330 exceeds a threshold level, a default action (e.g., default scrolling speed) may be modified commensurate with the force input at 350. For example, a force input over a first threshold may result in a first speed of scrolling increase at a first level (e.g., 1.5× default speed), whereas a force exceeding a second, higher threshold may trigger a further increase in scrolling speed. The reverse may also be executed in a similar fashion (e.g., reducing force as measured via an input device may decrease intensity of a default action, e.g., scrolling speed, as the force measured decreases through one or more thresholds. Thus, a user may increase a default action's intensity (e.g., speed of scrolling) from a default by applying more pressure, and decrease the default action's intensity by releasing the pressure.

The rate of change in force can also be used as a modifier. For example, when scrolling, a slow change in force (e.g., as measured by iteration of steps 310, 320, followed by a rate of change determination) may result in a slow change in speed. If the user quickly applied more force, then the speed of the change is measured to be rapid, may result in an increased change in speed, and could even trigger a reverse action. For example, a sudden increase in force input supplied during a scrolling action could stop the progressive modification (e.g., halting or stopping the scrolling, analogous to slamming on the brakes in a car). Conversely, the sudden increase in force may further intensify the progressive scrolling action to a maximum intensity, e.g., analogous to hitting the gas pedal. These responses to rate of change may likewise be user adjustable/definable.

Default action modification may be achieved by utilizing force input measurements to invoke different gain or response curves. Invoking different response curves allows for the granular adjustment of input, such as change in cursor movement speed. Intervals of force matched to predetermined thresholds may be designated to specific gain/response curves. For example, forces below a given level, X, would invoke gain/response curve A; whereas forces between given levels, X and Y, would invoke gain/response curve B; and forces above a given level, Y, would invoke gain/response curve C. There may be many such force intervals, gain/response curves, or combinations of forces and gain/response curves. Different combinations may be better suited for different scenarios and default action modifications.

Another approach to the gain/response curve modification is to include transition response curves. These may ease the transition between gain/response curves to avoid any perceived or actual jerky default action modifications. These transition curves may be specified to each possible transition to provide the optimal experience.

Force modification input provides distinct benefits over the conventional default actions based on conventional input signals. For example, current scrolling methods require users to use flick motions or maintain contact for a given duration of time to increase the speed. These methods lack transparency because users may be unaware of flicking and other gestures. Also, there is a learning curve for users to match the actions to their desired responses. Most people naturally have substantial sensitivity to pressure in their fingertips. Using this aspect in actions, such as scrolling, is more intuitive for users. Also, users lack granular control of the speed of the scrolling with current methods. Because of the force sensitivity of the fingertips, users can intuitively use force to modify and control the speed of scrolling or other actions according to embodiments.

Users may adjust the force change characteristics to fit their preferences for each type of interaction or default action to be modified. For example, some users may want scroll speed to increase when more force is applied while others may want the scroll speed to decrease (this may also apply to pointer movement and other default action modifications). Like most other forms of input, it is possible to disable force as a modifier for specific actions or globally, for example as a user choice.

Example circumstances where force modification could be useful include but are not limited to the following. For moving a cursor, a change in force may be used to modify cursor speed to accommodate honing and ballistic motions, thus appropriately adjusting the speed of cursor movement to enable quick cursor movement when desired, as well as slower cursor movement. Changes in pressure may thus invoke changes in gain. The change produced by the force may be user selectable. For example, in some scenarios, harder presses on an input device such as a touch screen invoke a more accurate response curve with lower gain, allowing greater precision. In other scenarios, softer presses invoke the more accurate response curve, with harder presses increasing the gain.

For scrolling, a change in force may modify acceleration of the scroll action. Coasting (i.e., continued scrolling with continued pressure input and without directional movement) may be invoked by adjusting the force at the end of a directional scroll motion or maintaining the force input at the end of a directional scroll motion. For example, a user may increase, decrease, or maintain force input at the end of a directional scroll action to continue coasting. Alternatively, a force input maintained or supplied (e.g., increased force) may stop or slow (reduce the gain) of a scrolling action.

For adjustment of settings, by utilizing a default action (e.g., holding down a mechanical button), but imparting differing force input (e.g., via pressing harder), an embodiment may change gain in the settings adjustment, e.g., change the units of the setting more quickly. For example, instead of incrementing a setting by 1 unit/second, the increased force may change the gain of settings modification to 10 units/second. An embodiment may use force input to modify or adjust settings such as changing channels on a television (using a remote control), adjusting the time on a clock, or any other setting with multiple incremental units. Greater force could result in greater changes (either faster or larger increments) in units.

For adjusting feedback, changes in force result in changes in magnitude of feedback provided by an information handling device. The feedback may include feedback means such as haptic or audio feedback. Thus, if a user is pressing with more force on a touch screen, the information handling device may modify a default action, such as haptic or audio feedback action, to commensurately increase (e.g., proportionally) the haptic or audio feedback provided to the user. This may correspond to an attempt to match the physiological necessities of the situation, for example supplying greater haptic feedback to a user on a harder press, as a lighter/default haptic feedback may go unnoticed due to the pressure of the input. Moreover, this modification of a default feedback action may provide the user with additional information, such as a proportional feedback indicative of the sensed force, thus providing the user with a metric of how much force is being supplied to the input device.

Accordingly, the various embodiments utilize an input device capable of measuring force input and leverage the additional force input information in modifying one or more default actions of an information handling device. The various example embodiments have been described in connection with facilitating default action modifications, as described using non-limiting examples. Embodiments may be used to provide similar functionality and services in other contexts. Similarly, although devices such as tablets, smart phones, laptops, television devices and the like have been used in the description as specific examples, embodiments may be utilized in connection with other types of devices.

It will also be understood that the various embodiments may be implemented in one or more information handling devices configured appropriately to execute program instructions consistent with the functionality of the embodiments as described herein. In this regard, FIG. 1 and FIG. 2 illustrate non-limiting examples of such devices and components thereof.

As will be appreciated by one skilled in the art, various aspects may be embodied as a system, method or computer program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device/computer readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving force input in a z direction with respect to a planar surface of an input device of an information handling device;
measuring the force input at the input device; and
modifying one or more actions of the information handling device commensurate with the measured force input;
wherein the one or more actions are associated with input along the planar surface.

2. The method of claim 1, wherein modifying one or more actions of the information handling device commensurate with the measured force input further comprises:
determining a level of force input exceeding a threshold; and
modifying an action according to a response curve.

3. The method of claim 2, wherein one or more of the threshold and the response curve is user adjustable.

4. The method of claim 1, wherein modifying the one or more actions comprises one or more of: modifying cursor movement, modifying scrolling, modifying one or more settings, and modifying feedback provided to a user.

5. The method of claim 4, wherein modifying cursor movement comprises modifying cursor movement gain commensurate with the measured force input.

6. The method of claim 4, wherein modifying scrolling comprises modifying scrolling gain commensurate with the measured force input.

7. The method of claim 6, wherein modifying scrolling gain commensurate with the measured force input further comprises:
ascertaining a force input exceeding a first threshold;
modifying scrolling gain; and
continuing a scrolling action using modified scrolling gain until ascertaining removal of the force input exceeding the first threshold.

8. The method of claim 4, wherein modifying feedback provided to a user comprises modifying a level of feedback provided to the user commensurate with the measured force input.

9. The method of claim 1, wherein the input device is one or more of a mechanical input device and a resistive input device.

10. An information handling device, comprising:
a input device having a planar surface;
a force sensor coupled to the planar input device;
one or more processors; and
a memory operatively coupled to the one or more processors that stores instructions executable by the one or more processors to perform acts comprising:
detecting, at the force sensor, a force input in a z direction with respect to the planar surface of the input device;
measuring the force input at the input device based on the force input; and
modifying one or more actions of the information handling device commensurate with the measured force input;
wherein the one or more actions are associated with input along the planar surface.

11. The information handling device of claim 10, wherein modifying one or more actions of the information handling device commensurate with the measured force input further comprises:
determining a level of force input exceeding a threshold; and
modifying a default action according to a response curve.

12. The information handling device of claim 10, wherein one or more of the threshold and the response curve is user adjustable.

13. The information handling device of claim 10, wherein modifying the one or more actions comprises one or more of: modifying cursor movement, modifying scrolling, modifying one or more settings, and modifying feedback provided to a user.

14. The information handling device of claim 13, wherein modifying cursor movement comprises modifying cursor movement gain commensurate with the measured force input.

15. The information handling device of claim 13, wherein modifying scrolling comprises modifying scrolling gain commensurate with the measured force input.

16. The information handling device of claim 15, wherein modifying scrolling gain commensurate with the measured force input further comprises:
ascertaining a force input exceeding a first threshold;
modifying scrolling gain; and
continuing a scrolling action using modified scrolling gain until ascertaining removal of the force input exceeding the first threshold.

17. The information handling device of claim 13, wherein modifying feedback provided to a user comprises modifying a level of feedback provided to the user commensurate with the measured force input.

18. A program product, comprising:
a storage medium having computer program code embodied therewith, the computer program code comprising:
computer program code configured to receive force input in a z direction with respect to a planar surface of an input device of an information handling device;
computer program code configured to measure the force input at the input device; and
computer program code configured to modify one or more actions of the information handling device commensurate with the measured force input;
wherein the one or more actions are associated with input along the planar surface.
